(19) United States
(12) Patent Application Publication
(10) Pub. No.: US 2024/0233107 A1
(43) Pub. Date: Jul. 11, 2024

(54) Image Processing Method and Apparatus, Optical System, and Computer-Readable Storage Medium

(71) Applicant: SKYVERSE TECHNOLOGY CO., LTD., Shenzhen (CN)

(72) Inventors: Lu CHEN, Shenzhen (CN); Aihua XIA, Shenzhen (CN); Tiancheng ZUO, Shenzhen (CN); Jianpeng LIU, Shenzhen (CN); Song ZHANG, Shenzhen (CN)

(21) Appl. No.: 18/286,341

(22) PCT Filed: Apr. 8, 2022
(86) PCT No.: PCT/CN2022/085671

§ 371 Date: Oct. 10, 2023

(30) Foreign Application Priority Data
Apr. 12, 2021 (CN) 202110385940.7

(51) Int. Cl. G06T 7/00; G06T 7/60

(52) U.S. Cl. CPC G06T 7/0004; G06T 7/60; G06T 2207/30148

(57) ABSTRACT

The present application discloses an image processing method and apparatus, an optical system, and a computer-readable storage medium. The method comprises: acquiring parameters of rectangular images of inner ring portions and outer ring portions of an object to be inspected; preprocessing, according to the parameters of the rectangular images of the inner ring portions and the outer ring portions, the rectangular images of inner ring portions and the rectangular images of outer ring portions to form a rectangular image of the object; initializing parameters of a target circular image according to the rectangular image of the object; and determining pixel mapping relationships between the target circular image and the rectangular image of the object, and determining pixel values on the target circular image according to the pixel mapping relationships and pixel values on the rectangular image of the object.

### CROSS-REFERENCE TO RELATED APPLICATIONS

This application claims the priority to Chinese patent application No. 202110385940.7, titled “IMAGE PROCESSING METHOD AND APPARATUS, OPTICAL SYSTEM, AND COMPUTER-READABLE STORAGE MEDIUM”, filed on Apr. 12, 2021 with the China National Intellectual Property Administration, which is incorporated herein by reference in its entirety.

### TECHNICAL FIELD

The present disclosure relates to the technical field of image processing, and in particular to a method and a device for processing an image, an optical system, and a computer readable storage medium.

### BACKGROUND OF THE INVENTION

In conventional technology, during the quality detection for defects of a wafer, images of the wafer are usually captured by a camera, followed by the detection based on the images. When capturing the images of the wafer, the camera and the wafer rotate relatively to enable the camera to scan the whole wafer. Nevertheless, since the original images captured by the camera are rectangular in shape, it is required to restore these rectangular original images into a circular image to form an image of the whole wafer.

### SUMMARY OF THE INVENTION

According to embodiments of the present disclosure, a method and a device for processing an image, an optical system, and a computer readable storage medium are provided to restore a circular image of a to-be-detected object, which can facilitate the detection of the to-be-detected object.

A method for processing an image is provided according to an embodiment of the present disclosure, the method includes:

acquiring parameters of rectangular images of an inner ring portion and an outer ring portion of a to-be-detected object obtained by scanning in a rotating manner:

pre-processing, based on the parameters of the rectangular images of the inner ring portion and the outer ring portion, a plurality of rectangular images of the inner ring portion and a plurality of rectangular images of the outer ring portion, to form a rectangular image of the to-be-detected object:

initializing, based on the rectangular image of the to-be-detected object, parameters of a target circular image; and

determining a pixel mapping relationship between the target circular image and the rectangular image of the to-be-detected object, and determining, based on the pixel mapping relationship and a pixel value of the rectangular image of the to-be-detected object, a pixel value of the target circular image.

In some embodiments, the rectangular images of the inner ring portion and the rectangular images of the outer ring portion are captured by two line scan cameras respectively, and the two line scan cameras are arranged in a radial direction of the to-be-detected object.

In some embodiments, the parameters of the rectangular images of the inner ring portion and the outer ring portion include a redundant width of the rectangular image of the inner ring portion, an overlapping width of the inner ring portion and the outer ring portion, a quantity of rows of the to-be-detected object rotated once, and a quantity of rows moved of the rectangular image of the inner ring portion and/or the outer ring portion.

In some embodiments, the pre-processing includes:

cropping, based on the quantity of rows of the to-be-detected object rotated once, redundant rows in the rectangular images of the inner ring portion and the rectangular images of the outer ring portion:

cropping, based on the redundant width of the rectangular image of the inner ring portion, redundant parts of the rectangular images of the inner ring portion:

cropping, based on the overlapping width of the inner ring portion and the outer ring portion, the rectangular images of the inner ring portion and/or the rectangular images of the outer ring portion: and

splicing, based on the quantity of rows moved of the rectangular image of the inner ring portion and/or the outer ring portion, a plurality of cropped rectangular images of the outer ring portion and a plurality of cropped rectangular images of the inner ring portion, to acquire the rectangular image of the to-be-detected object.

In some embodiments, the parameters of the target circular image include a radius and a spatial matrix of the target circular image,

the initializing, based on the rectangular image of the to-be-detected object, parameters of a target circular image includes:

setting the radius of the target circular image to be equal to a width of the rectangular image of the to-be-detected object; and

initializing the spatial matrix, where the spatial matrix is a matrix of 2R*2R, and R represents the radius of the target circular image.

In some embodiments, the determining the pixel mapping relationship between the target circular image and the rectangular image of the to-be-detected object includes:

extracting all points in the spatial matrix of the target circular image that are apart from a central point of the spatial matrix less than or equal to the radius of the target circular image; and

mapping all the extracted points back to corresponding positions in the rectangular image of the to-be-detected object through a preset function to determine the pixel mapping relationship.

In some embodiments, the preset function includes a conversion relationship between coordinates of a pixel point in the target circular image and coordinates of a pixel point in the rectangular image of the to-be-detected object.

A device for processing an image is provided according to an embodiment of the present disclosure, the device includes:

an acquisition unit, configured to acquire parameters of rectangular images of an inner ring portion and an outer ring portion of a to-be-detected object obtained by scanning in a rotating manner:

a pre-processing unit, configured to pre-process a plurality of rectangular images of the inner ring portion and a plurality of rectangular images of the outer ring portion based on the parameters of the rectangular images of the inner ring portion and the outer ring portion to form a rectangular image of the to-be-detected object:

an initialization unit, configured to initialize parameters of a target circular image based on the rectangular image of the to-be-detected object; and

a determination unit, configured to determine a pixel mapping relationship between the target circular image and the rectangular image of the to-be-detected object, and determine a pixel value of the target circular image based on the pixel mapping relationship and a pixel value of the rectangular image of the to-be-detected object.

In some embodiments, the rectangular images of the inner ring portion and the rectangular images of the outer ring portion are captured by two line scan cameras respectively, and the two line scan cameras are arranged in a radial direction of the to-be-detected object.

In some embodiments, the parameters of the rectangular images of the inner ring portion and the outer ring portion include a redundant width of the rectangular image of the inner ring portion, an overlapping width of the inner ring portion and the outer ring portion, a quantity of rows of the to-be-detected object rotated once, and a quantity of rows moved of the rectangular image of the inner ring portion and/or the outer ring portion.

In some embodiments, the pre-processing unit includes:

a first cropping sub-unit, configured to crop redundant rows in the rectangular images of the inner ring portion and the rectangular images of the outer ring portion based on the quantity of rows of the to-be-detected object rotated once:

a second cropping sub-unit, configured to crop redundant parts of the rectangular images of the inner ring portion based on the redundant width of the rectangular image of the inner ring portion:

a third cropping sub-unit, configured to crop the rectangular images of the inner ring portion and/or the rectangular images of the outer ring portion based on the overlapping width of the inner ring portion and the outer ring portion; and

a processing sub-unit, configured to splice a plurality of cropped rectangular images of the outer ring portion and a plurality of cropped rectangular images of the inner ring portion based on the quantity of rows moved of the rectangular image of the inner ring portion and/or the outer ring portion to acquire the rectangular image of the to-be-detected object.

In some embodiments, the parameters of the target circular image include a radius and a spatial matrix of the target circular image, the initialization unit is configured to:

set the radius of the target circular image to be equal to a width of the rectangular image of the to-be-detected object; and

initialize the spatial matrix, wherein the spatial matrix is a matrix of 2R*2R, and R represents the radius of the target circular image.

In some embodiments, the determination unit includes:

an extraction sub-unit, configured to extract all points in the spatial matrix of the target circular image that are apart from a central point of the spatial matrix less than or equal to the radius of the target circular image; and

a mapping sub-unit, configured to map all the extracted points back to corresponding positions in the rectangular image of the to-be-detected object through a preset function to determine the pixel mapping relationship.

In some embodiments, the preset function includes a conversion relationship between coordinates of a pixel point in the target circular image and coordinates of a pixel point in the rectangular image of the to-be-detected object.

A device for processing an image is provided according to an embodiment of the present disclosure, the device includes: a memory, a processor, and a computer program stored in the memory and executable on the processor, where the processor, when executes the computer program, implements the steps in the method for processing the image according to any one of the foregoing embodiments.

An optical system is provided according to an embodiment of the present disclosure, the system includes the device for processing the image according to any one of the foregoing embodiments.

A computer readable storage medium storing a computer program thereon is provided according to an embodiment of the present disclosure. The computer program, when executed by a processor, implements the steps in the method for processing the image according to any one of the foregoing embodiments.

According to the method and the device for processing an image, the optical system, and the computer readable storage medium, a rectangular image of a to-be-detected object is obtained by pre-processing rectangular images of an inner ring portion and an outer ring portion of the to-be-detected object obtained by scanning in a rotating manner, and thus a pixel mapping relationship is obtained and pixel values of a target circular image are determined. In this way, the circular image of the to-be-detected object may be restored, which can intuitively observe the quality of the whole to-be-detected object and mark the identified defects.

Additional aspects and advantages of the present disclosure are set forth in part in the description below, which can become obvious from the following description or be understood through the practice of the present disclosure.

### BRIEF DESCRIPTION OF THE DRAWINGS

FIG. 1 is a schematic flowchart of a method for processing an image according to an embodiment of the present disclosure;

FIG. 2 is a schematic structural diagram of a detection device according to an embodiment of the present disclosure:

FIG. 3 is a schematic structural diagram of a detection device according to another embodiment of the present disclosure:

FIG. 4 is a rectangular image of an inner ring portion of a to-be-detected object according to an embodiment of the present disclosure:

FIG. 5 is a rectangular image of an outer ring portion of a to-be-detected object according to an embodiment of the present disclosure:

FIG. 6 is a schematic diagram of a comparison between a rectangular image and a target circular image of a to-be-detected object according to an embodiment of the present disclosure:

FIG. 7 is a schematic block diagram of a device for processing an image according to an embodiment of the present disclosure;

FIG. 8 is a schematic block diagram of a device for processing an image according to another embodiment of the present disclosure;

FIG. 9 is a schematic block diagram of a device for processing an image according to still another embodiment of the present disclosure; and

FIG. 10 is a schematic block diagram of a device for processing an image according to yet another embodiment of the present disclosure.

### DETAILED DESCRIPTION OF EMBODIMENTS

Embodiments of the present disclosure are described in detail below: Examples of the embodiments are shown in the drawings. Throughout the drawings, the same or similar reference signs denote the same or similar elements or elements having the same or similar functions. The embodiments described below with reference to the drawings are illustrative, which are only used for explaining the present disclosure and should not be construed as limitations to the present disclosure.

In the description of the present disclosure, the terms “first” and “second” are used for descriptive purposes only, which should not be understood as indicating or implying relative importance or implicitly indicating the quantity of indicated technical features. Therefore, the features defined by “first” and “second” may explicitly or implicitly include one or more features. In the description of the present disclosure, the meaning of “multiple” is two or more, unless specifically defined otherwise.

In the description of the present disclosure, it should be noted that, unless otherwise explicitly specified and defined, the term such as “installation”, “link” and “connection” should be understood in a broad sense. For example, such term may refer to a fixed connection, a detachable connection, or an integrated connection. The term may refer to a mechanical connection or an electrical connection. The term may refer to a direct connection, an indirect connection through an intermediate medium, or an internal communication between two components or an interactive relationship between two components. Those skilled in the art should understand specific meanings of the above terms in the present disclosure based on specific situations.

Various embodiments or examples are provided in the present disclosure to implement different structures of the present disclosure. In order to simplify the present disclosure, components and arrangements in specific examples are described hereinafter. Apparently, they are only examples and are not intended to limit the present disclosure. Furthermore, according to the present disclosure, reference numerals and/or reference letters may be repeated in different examples for the purpose of simplicity and clarity, which do not indicate a relationship between various embodiments and/or arrangements discussed. In addition, although examples of various specific processes and materials are provided according to the present disclosure, those skilled in the art may appreciate the application of other processes and/or the use of other materials.

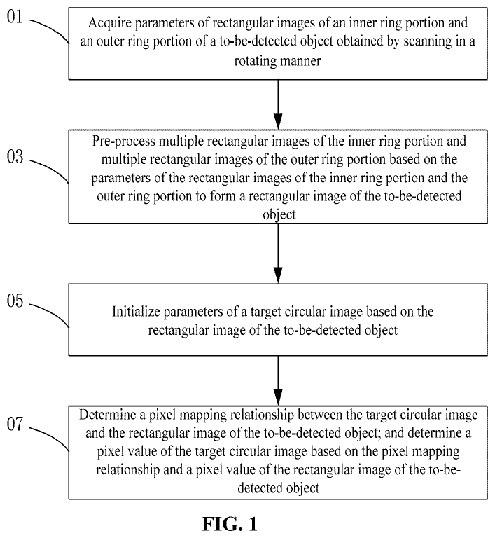

Reference may be made to FIG. 1, which is a schematic flowchart of a method for processing an image according to an embodiment of the present disclosure. As shown in FIG. 1, the method for processing the image includes step 01, step 03, step 05 and step 07 as follows.

In step 01, parameters of rectangular images of an inner ring portion and an outer ring portion of the to-be-detected object obtained by scanning in a rotating manner are acquired.

In an embodiment, the to-be-detected object may be any circular or nearly circular object. In an example, the to-be-detected object is a wafer. An image of the wafer may be collected by a line scan camera. The image of the wafer collected by the line scan camera is rectangular, which may be referred to as a rectangular image. In the following description, to illustrate the present disclosure, as an example, the to-be-detected object is a wafer. However, it should be understood that the to-be-detected object is not limited to the wafer, rather, it may also be other object for defect quality detection through image collection, which is not limited here.

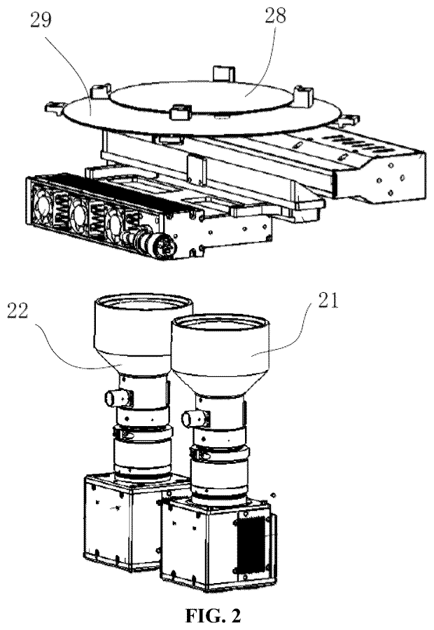

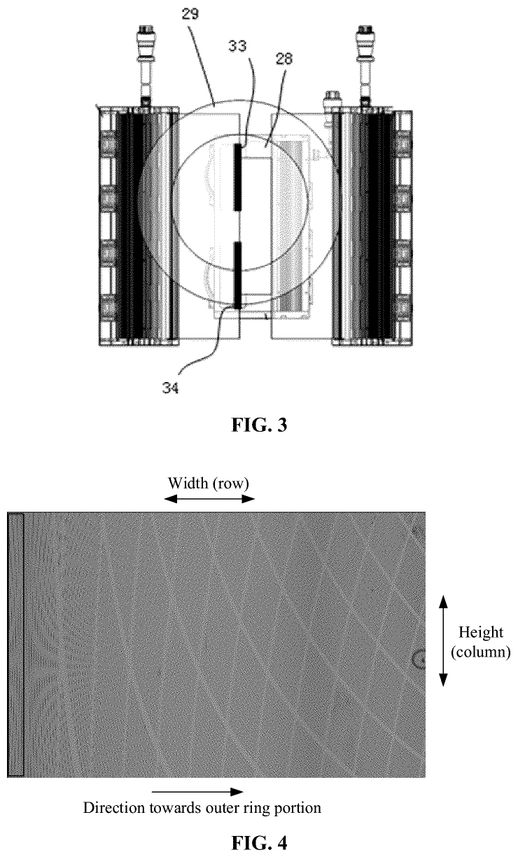

FIG. 2 and FIG. 3 are respectively schematic structural diagrams of detection devices according to the embodiments of the present disclosure. In an embodiment, in combination with FIG. 2 and FIG. 3, the rectangular images of the inner ring portion and the rectangular images of the outer ring portion are captured by two line scan cameras respectively, where the two line scan cameras are arranged in a radial direction of the to-be-detected object. In this way, the occupied area of the detection device may be reduced.

Generally, in conventional technology, for quality detection on defects of the wafer, images are captured by an area scan camera generally in horizontal and vertical capturing directions, and obtained images are restored to a circular image. Such circular image is used for observing the quality of the whole wafer more intuitively and marking the identified defects on the circular image.

As it is required for the area scan camera to use a horizontal driving mechanism and a vertical driving mechanism, the detection device ends up with a large size. In FIG. 2, two line scan cameras include a first line scan camera 21 and a second line scan camera 22, which are placed below the wafer. The first line scan camera 21 captures an outer ring portion of the wafer, and the second line scan camera 22 captures an inner ring portion of the wafer. The cameras move around the wafer to scan in a rotating manner, or the two line scan cameras are kept still while the wafer rotates once to scan the whole wafer. The scanned original images are rectangular, which are required to be restored to a circular image later. With reference to FIG. 3, a center of a field of view 33 of the second line scan camera 22 is 40 mm away from a center of the wafer, and a center of a field of view 34 of the first line scan camera 21 is 110 mm away from the center of the wafer. In the embodiment, the field of view of each imaging optical path is 80 mm, thus, a sum of two fields of view is greater than a radius of 150 mm of a 12-inch wafer, which can enable the wafer to rotate once to complete a scan. It should be noted that the above specific numerical values and the following specific numerical values are intended to facilitate the implementation of the present disclosure, which should not be understood as limitations to the present disclosure.

In addition, the detection device may also detect wafers in different sizes, such as 6-inch, 8-inch and 12-inch. In an example of FIG. 2, the detection device may detect a wafer 28 in 8-inch and a wafer 29 in 12-inch. It should be pointed out that during detection, one wafer is placed above the cameras. In a case that another wafer is required to be detected, the current wafer should be removed first, and then another wafer is placed above the cameras. In other words, wafers in 8-inch and 12-inch may not be detected at the same time, rather, only one wafer may be detected at a time.

Since the detection device according to the embodiment of the present disclosure collects images in a rotating manner, the wafer and the cameras may be placed in a vertical direction, and an overall length of the detection device is only required to be larger than a diameter of the wafer, which significantly reduces the occupied area of the detection device. It should be understood that although in FIG. 2, the cameras are placed below the wafer, in other embodiments, the cameras may be placed above the wafer or in other orientations, so long as a plane where the wafer is located is perpendicular to an optical axis of the cameras.

In step 03, multiple rectangular images of the inner ring portion and multiple rectangular images of the outer ring portion are pre-processed based on the parameters of the rectangular images of the inner ring portion and the outer ring portion to form a rectangular image of the to-be-detected object.

In an embodiment, since both the rectangular images of the inner ring portion and the rectangular images of the outer ring portion are images of parts of the to-be-detected object, it is required to form a rectangular image of the whole to-be-detected object.

In an example, the parameters of the rectangular images of the inner ring portion and the outer ring portion include a redundant width of the rectangular image of the inner ring portion, an overlapping width of the inner ring portion and the outer ring portion, a quantity of rows of the to-be-detected object rotated once, and a quantity of rows moved of the rectangular image of the inner ring portion and/or the outer ring portion.

Reference may be made to FIG. 4, which shows a rectangular image of an inner ring portion. A redundant width of the rectangular image of the inner ring portion is the area selected via a solid-line box on the left side of the image. With the redundant width of the rectangular image of the inner ring portion, a circular image may be restored through a restoration test, and whether a center of the circular image is distorted may be determined by manual visual inspection, machine detection or other manners. In a case that there is the distortion, the texture of the image is usually bended. By changing the redundant width (e.g., the quantity of columns) of the rectangular image of the inner ring portion, the distortion is within an expected range or disappeared. In this case, the redundant width of the rectangular image of the inner ring portion may be determined.

In order to ensure that the rectangular images of the inner ring portion and the rectangular images of the outer ring portion may be synthesized into a rectangular image of the whole wafer, an overlapping part may exist between the rectangular image of the inner ring portion and the rectangular image of the outer ring portion in a radial direction of the wafer. The overlapping width of the inner ring portion and the outer ring portion may be used to crop the overlapping part.

Similarly, overlapping part may exist between the multiple rectangular images of the inner ring portion in a rotation direction. The quantity of rows of the to-be-detected object rotated once may be the exact quantity of rows of the to-be-detected object rotated once, which may be acquired by manual visual inspection or machine detection. In fact, the quantity of rows in the acquired image is more than the exact quantity of rows. The same is applied to the multiple rectangular images of the outer ring portion. In the embodiment, the rows denote a width direction and the columns denote a height direction.

The quantity of rows moved of the rectangular image of the inner ring portion and/or the outer ring portion may be used to splice the rectangular images of the inner ring portion and the rectangular images of the outer ring portion later.

In general, the above parameters are constant in a case that structures, performance and the like of the detection device, a device for processing an image or an optical system are not changed, which may be fixed after being obtained by manual visual inspection or machine detection.

In an embodiment, in order to acquire a rectangular image of the whole to-be-detected object, the pre-processing includes steps as follows.

Based on the quantity of rows of the to-be-detected object rotated once, redundant rows in the rectangular images of the inner ring portion and the rectangular images of the outer ring portion are cropped.

Based on the redundant width of the rectangular image of the inner ring portion, the redundant parts of the rectangular images of the inner ring portion are cropped.

Based on the overlapping width of the inner ring portion and the outer ring portion, the rectangular images of the inner ring portion and/or the rectangular images of the outer ring portions are cropped.

Based on the quantity of rows moved of the rectangular images of the inner ring portion and/or the outer ring portion, multiple cropped rectangular images of the outer ring portion and multiple cropped rectangular images of the inner ring portion are spliced, to acquire the rectangular image of the to-be-detected object.

In an example, the rectangular images of the inner ring portion are provided for illustration. The quantity of rows of the inner ring portion is 4100 through manual visual inspection or machine detection on the multiple rectangular images of the inner ring portion. Based on a certain same reference object (e.g., a pattern on the rectangular image), there are 100 overlapping rows between the top and bottom of two adjacent rectangular images of the inner ring portion. As a result, the exact quantity of rows of the wafer rotated once may be 4000. Hence, the 100 overlapping rows are redundant, which are required to be cropped in the rectangular images of the inner ring portion. The same processing is applied to the rectangular images of the outer ring portion.

As the rectangular image of the inner ring portion shown in FIG. 4, a redundant width of the rectangular image of the inner ring portion is the area in the solid line box, which may be cropped.

The overlapping width of the inner ring portion and the outer ring portion is determined by finding a feature point appearing in both the rectangular image of the inner ring portion and the rectangular image of the outer ring portion, discarding the part on a right side of the feature point of the rectangular image of the inner ring portion, and discarding a part on a left side of the feature point of the rectangular image of the outer ring portion. In FIG. 4, a feature point of the rectangular image of the inner ring portion is the black point in a solid line circle. FIG. 5 illustrates a rectangular image of an outer ring portion of a to-be-detected object according to an embodiment of the present disclosure. In FIG. 5, the corresponding feature point of a rectangular image of the outer ring portion is the black point in a solid line circle.

For the quantity of rows moved of the rectangular image of the inner ring portion and/or the outer ring portion, in an embodiment, the quantity of rows moved of the rectangular image of the outer ring portion is provided as an example for illustration. Based on the rectangular images of the inner ring portion, the rectangular images of the outer ring portion are moved up and down to align with the rectangular images of the inner ring portion. In an embodiment, a coordinate yᵢₙₙₑᵣ and a coordinate yₒᵤₜₑᵣ corresponding to a same pattern in the rectangular images of the inner ring portion and the outer ring portion respectively are found, and yᵢₙₙₑᵣ-yₒᵤₜₑᵣ is the quantity of rows moved. It should be understood that in other embodiments, based on the rectangular image of the outer ring portion, the rectangular images of the inner ring portion may also be moved. Alternatively, the quantity of rows moved of the rectangular image of the inner ring portion and the quantity of rows moved of the rectangular image of the outer ring portion may be determined, and then the rectangular images of the inner ring portion and the rectangular images of the outer ring portion may be moved simultaneously or in a time-sharing manner, to splice a rectangular image of the whole wafer.

In step 05, parameters of a target circular image are initialized based on the rectangular image of the to-be-detected object.

In an embodiment, since it is required for a circular image of the wafer to be restored based on a rectangular image of the wafer, parameters of a target circular image are initialized based on the rectangular image of the wafer to establish a relationship between them. In an embodiment, the parameters of the target circular image include a radius and a spatial matrix of the target circular image.

In step 05, the method includes below:

a radius of the target circular image is set to be equal to a width of the rectangular image of the to-be-detected object; and

the spatial matrix is initialized, where the spatial matrix is a matrix of 2R*2R, and R represents the radius of the target circular image. In this way, a relationship may be established between the rectangular image and the circular image of the wafer.

In an example, the width of the rectangular image of the to-be-detected object may refer to the quantity T of pixels in the rectangular image of the to-be-detected object in a width direction, and thus the radius of the target circular image R=T. In the matrix of 2R*2R, a value of an element is a preset value, such as 0 or other numerical values, which is not limited here. This matrix is the spatial matrix of the target circular image.

In step 07, a pixel mapping relationship between the target circular image and the rectangular image of the to-be-detected object is determined, and a pixel value of the target circular image is determined based on the pixel mapping relationship and a pixel value of the rectangular image of the to-be-detected object.

In an embodiment, after obtaining the rectangular image of the wafer, each pixel value of the rectangular image of the wafer is filled in a pixel at a corresponding position in the target circular image to obtain the circular image of the wafer.

In an embodiment, in order to establish the pixel mapping relationship, in step 07, the method includes the following steps:

all points in the spatial matrix of the target circular image that are apart from a central point of the spatial matrix less than or equal to the radius of the target circular image are extracted: and

all the extracted points are mapped back to corresponding positions in the rectangular image of the to-be-detected object through a preset function to determine the pixel mapping relationship.

All points (pixel points) in the spatial matrix of the target circular image that are apart from a central point (pixel point) of the spatial matrix less than or equal to the radius of the target circular image R are extracted. In this way, based on the central point of the target circular image, all destination points are mapped back to the corresponding positions in the rectangular image of the wafer through a preset function, where the distance between each of the points and the central point is less than or equal to R. Each pixel value at the respective position on the rectangular image of the wafer is copied to the corresponding position in the matrix of the target circular image. After all pixels in the matrix of the target circular image are processed, the image is restored.

In an embodiment, the preset function includes a conversion relationship between coordinates of a pixel point in the target circular image and coordinates of a pixel point in the rectangular image of the to-be-detected object.

In an embodiment, the equation of the preset function for mapping the points in the target circular image that are apart from the central point less than or equal to R back to the rectangular image of the wafer is as follows.

A relationship for mapping coordinates (x, y) of a pixel point in the target circular image to coordinates (x′, y′) of a pixel point in the rectangular image of the wafer is:

$${x}^{′} = \sqrt{( X - R ) * ( X - R ) + ( Y - R ) * ( Y - R )} .$$

An included angle (angle) between the coordinates (x, y) of the pixel point in the target circular image and the central point (R,R) of the target circular image is then calculated, where the included angle ranges from −180° to 180°. Then, y′=a height of the rectangular image/2−the height of the rectangular image*angle/360. Next, a pixel value corresponding to (x′, y′) is copied to a pixel at a corresponding position (x, y) of the target circular image. After all the points in the target circular image are copied, the rectangular image is successfully converted to the target circular image. In an example, the pixel value may be a gray value of the pixel.

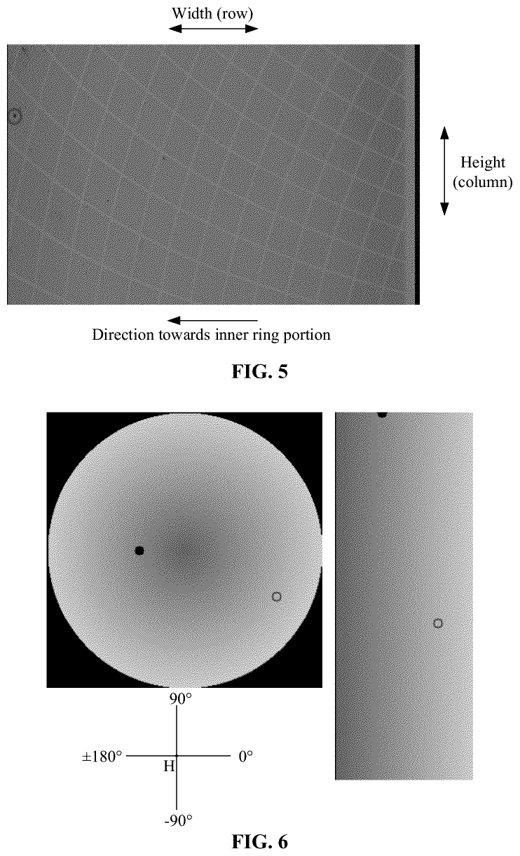

FIG. 6 is a schematic diagram showing a comparison between a rectangular image of a to-be-detected object and a target circular image according to an embodiment of the present disclosure. As an example, with reference to FIG. 6, a rectangular image of a wafer before restoration (right side) is 150 pixels wide and 400 pixels high. This image is assumed to be a pre-processed image and may be directly used to restore a target circular image. Then, a radius of the target circular image R is calculated. The radius of the target circular image R is equal to the width of the rectangular image, i.e., R=150, and a matrix of the target circular image is 300*300. For example, in FIG. 6, the coordinates of a point in an upper left corner of a square (a graph where the target circular image is located) is the origin coordinates, the top side towards right is a positive direction of a X axis, and the left side towards down is a positive direction of a Y axis. Angular distributions of pixel points in the target circular image are shown in FIG. 6 (point H of an angular distribution image is equivalent to a central point of the target circular image), the coordinates of the point in an upper left corner of the rectangular image is the origin coordinates, the top side towards right is a positive direction of a X axis, and the left side towards down is a positive direction of a Y axis. For a point in the target circular image with x=100 and y=150, such as a central point of a solid circle in the target circular image on the left of FIG. 6, a central point of a solid circle in the rectangular image on the right of FIG. 6, i.e., x′=50 and y′=0, may be found by the equation of the pixel mapping relationship, and a pixel value of (x′, y′) is copied to a pixel at (x, y) to restore a pixel point in the target circular image. For a central point of a hollow circle in the target circular image with coordinates of x=250 and y=200, a central point of a hollow circle in the rectangular image with coordinates of x′=111 and y′=229 is calculated through the pixel mapping relationship, and a pixel value of the coordinates (111,229) in the rectangular image is copied to a pixel (250,200) in the target circular image to restore another pixel point. The step of mapping all points on the target circular image back to the rectangular image and copying the pixel values of the rectangular image to the pixels in corresponding positions of the target circular image is repeated to complete the restoration.

In an example, the rectangular image of the wafer may be obtained by processing 20 rectangular images of the inner ring portion and 20 rectangular images of the outer ring portion.

In addition, in a specific implementation process, in order to speed up the method for processing the image, GPU acceleration and CUDA kernel function may be used to process a mapping relationship of pixel points (x, y) and (x′, y′) instead of CPU loop execution.

Based on the above description, in the method for processing an image according to an embodiment of the present disclosure, a rectangular image of a to-be-detected object is obtained by pre-processing rectangular images of inner ring portion and outer ring portion of the to-be-detected object obtained by scanning in a rotating manner, and thus a pixel mapping relationship is acquired and pixel values of a target circular image are determined. In this way, the circular image of the to-be-detected object may be restored, which can intuitively observe the quality of the whole to-be-detected object and mark identified defects.

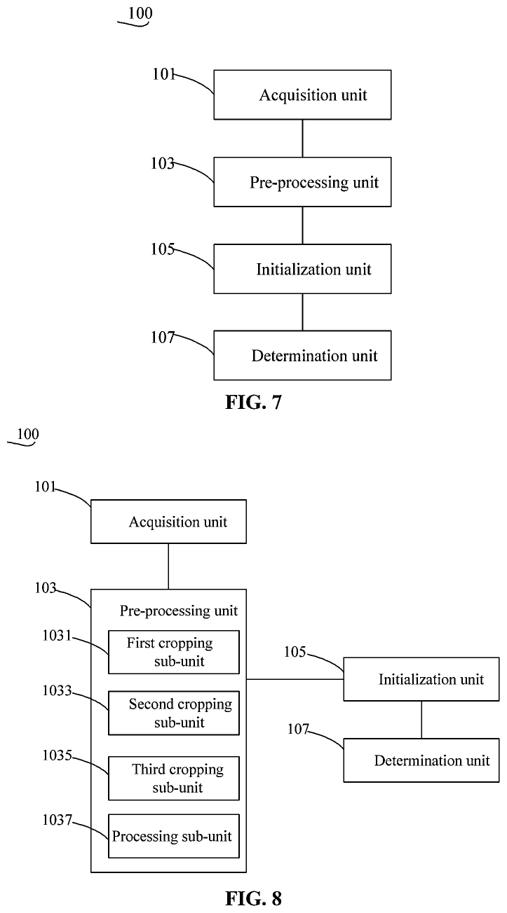

FIG. 7 is a schematic block diagram of a device for processing an image according to an embodiment of the present disclosure. With reference to FIG. 7, a device 100 for processing an image according to an embodiment of the present disclosure includes an acquisition unit 101, a pre-processing unit 103, an initialization unit 105 and a determination unit 107.

The acquisition unit 101 is configured to acquire parameters of rectangular images of an inner ring portion and an outer ring portion of a to-be-detected object obtained by scanning in a rotating manner.

The pre-processing unit 103 is configured to pre-process multiple rectangular images of the inner ring portion and multiple rectangular images of the outer ring portion based on the parameters of the rectangular images of the inner ring portion and the outer ring portion to form a rectangular image of the to-be-detected object.

The initialization unit 105 is configured to initialize parameters of a target circular image based on the rectangular image of the to-be-detected object.

The determination unit 107 is configured to determine a pixel mapping relationship between the target circular image and the rectangular image of the to-be-detected object, and determine a pixel value of the target circular image based on the pixel mapping relationship and a pixel value of the rectangular image of the to-be-detected object.

In some embodiments, the rectangular images of the inner ring portion and the rectangular images of the outer ring portion are captured by two line scan cameras respectively, and the two line scan cameras are arranged in a radial direction of the to-be-detected object.

In some embodiments, the parameters of the rectangular images of the inner ring portion and the outer ring portion include a redundant width of the rectangular image of the inner ring portion, an overlapping width of the inner ring portion and the outer ring portion, a quantity of rows of the to-be-detected object rotated once, and a quantity of rows moved of the rectangular image of the inner ring portion and/or the outer ring portion.

FIG. 8 is a schematic block diagram of a device for processing an image according to another embodiment of the present disclosure. In some embodiments, with reference to FIG. 8, the pre-processing unit 103 includes a first cropping sub-unit 1031, a second cropping sub-unit 1033, a third cropping sub-unit 1035 and a processing sub-unit 1037.

The first cropping sub-unit 1031 is configured to crop redundant rows in the rectangular images of the inner ring portion and the rectangular images of the outer ring portion based on the quantity of rows of the to-be-detected object rotated once.

The second cropping sub-unit 1033 is configured to crop redundant parts of the rectangular images of the inner ring portion based on the redundant width of the rectangular image of the inner ring portion.

The third cropping sub-unit 1035 is configured to crop the rectangular images of the inner ring portion and/or the rectangular images of the outer ring portion based on the overlapping width of the inner ring portion and the outer ring portion.

The processing sub-unit 1037 is configured to splice multiple cropped rectangular images of the outer ring portion and multiple cropped rectangular images of the inner ring portion based on the quantity of rows moved of the rectangular image of the inner ring portion and/or the outer ring portion to acquire the rectangular image of the to-be-detected object.

In some embodiments, the parameters of the target circular image include a radius and a spatial matrix of the target circular image.

The initialization unit 105 is configured to:

set the radius of the target circular image to be equal to a width of the rectangular image of the to-be-detected object; and

initialize the spatial matrix, where the spatial matrix is a matrix of 2R*2R, and R represents the radius of the target circular image.

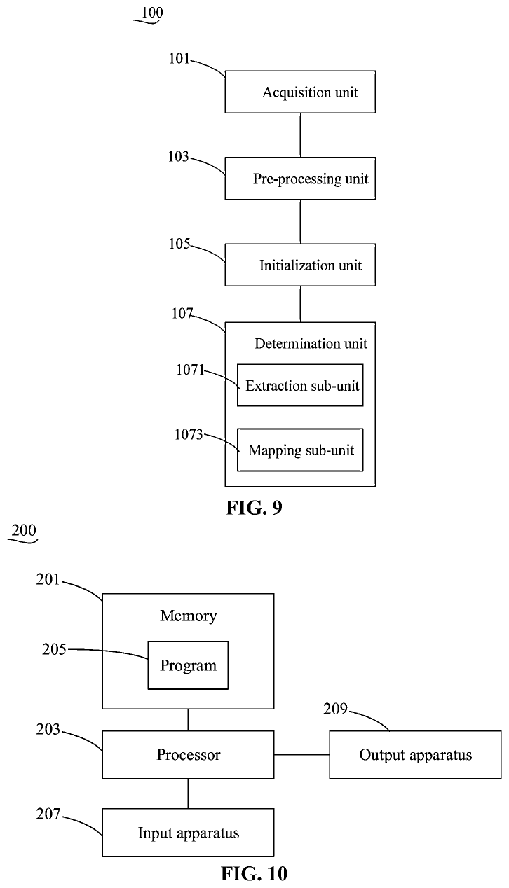

FIG. 9 is a schematic block diagram of a device for processing an image according to still another embodiment of the present disclosure. In some embodiments, with reference to FIG. 9, the determination unit 107 includes an extraction sub-unit 1071 and a mapping sub-unit 1073.

The extraction sub-unit 1071 is configured to extract all points in the spatial matrix of the target circular image that are apart from a central point of the spatial matrix less than or equal to the radius of the target circular image.

The mapping sub-unit 1073 is configured to map all the extracted points back to corresponding positions in the rectangular image of the to-be-detected object through a preset function to determine the pixel mapping relationship.

In some embodiments, the preset function includes a conversion relationship between coordinates of a pixel point in the target circular image and coordinates of a pixel point in the rectangular image of the to-be-detected object.

FIG. 10 is a schematic block diagram of a device for processing an image according to yet another embodiment of the present disclosure. With reference to FIG. 10, a device 200 for processing an image according to an embodiment of the present disclosure includes: a memory 201, a processor 203, and a computer program 205 stored in the memory 201 and executable on the processor 203, where the processor 203 is configured to execute the computer program 205 to implement the steps in the method for processing the image according to the foregoing embodiments.

The processor 203 includes, but is not limited to, a central processing unit (CPU) and a graphics processor (GPU). In addition, the device 200 for processing the image may further include an input apparatus 207 and an output apparatus 209 connected to the processor 203. The input apparatus 207 may be used for a user to input an instruction and a related setting. The input apparatus 207 includes, but is not limited to, a mouse, a keyboard, a touch screen, and a microphone and the like. The output apparatus 209 may be used to output a corresponding result, such as displaying an image and playing a sound, etc. The output apparatus 209 includes, but is not limited to, a display screen, a speaker, an indicator light, a buzzer, and a vibration motor, etc.

An optical system is further provided according to an embodiment of the present disclosure, which includes the device for processing the image according to any one of the foregoing embodiments.

In an embodiment, the optical system may include the foregoing detection device, and the device 100 or 200 for processing the image is configured to acquire rectangular images of inner ring portion and outer ring portion of a wafer from the detection device. The optical system may be applied to, but not limited to, scenes such as quality defect detection.

A computer readable storage medium storing a computer program is further provided according to an embodiment of the present disclosure. The computer program, when executed by a processor, causes the processor to implement the steps in the method for processing the image according to the foregoing embodiments.

It should be pointed out that the above explanations of the embodiments and beneficial effects of the method for processing an image are also applicable to the devices 100 and 200 for processing an image, the optical system and the computer readable storage medium according to the embodiments of the present disclosure, which are not repeated here.

Any reference in this specification to “an embodiment”, “some embodiments”, “certain embodiments”, “exemplary embodiments”, “an example”, “a specific example”, “an implementation” or “some examples” or the like means that specific features, structures, materials or characteristics described in combination with the embodiment or example is included in at least one embodiment or example of the present disclosure. In the specification, the schematic expressions of the above terms do not necessarily refer to the same embodiment or example. Furthermore, the specific features, structures, materials or characteristics described may be combined in any one or more embodiments or examples in a suitable manner.

Any process or method description in the flowchart or described in other ways herein may be understood as representing a module, segment or part of code that includes one or more executable instructions for implementing specific logical functions or steps of the process, and the scope of preferred embodiments of the present disclosure includes other preferred embodiment, in which functions may be implemented not in the order shown or discussed, including in a substantially simultaneous manner or in a reverse order based on the functions involved, which should be understood by those skilled in the art to which embodiments of the present disclosure belong.

The logic and/or the steps represented in the flowchart or described in other ways herein, for example, may be considered as a sequence list of executable instructions for implementing logic functions, and may be specifically implemented in any computer readable medium for the use by an instruction execution system, apparatus or device (such as a computer-based system, a system including a processor or other system capable of taking and executing instructions from the instruction execution system, the apparatus or the device), or for the use in combination with the instruction execution system, the apparatus or the device. In the specification, the “computer readable medium” may be any apparatus containing, storing, communicating, propagating or transmitting a program for use by the instruction execution system, apparatus or device or in combination with the instruction execution system, apparatus or device. More specific examples (non-exhaustive list) of the computer readable medium include: an electrical connection part (control method) with one or more wiring, a portable computer disk case (a magnetic apparatus), a random access memory (RAM), a read-only memory (ROM), an erasable programmable read-only memory (EPROM or flash memory), a fiber optic apparatus, and a portable compact disk read-only memory (CDROM). In addition, the computer readable medium may even be paper or other suitable medium on which the program is printed, since the program may be obtained electronically, for example, by optically scanning the paper or other medium, followed by editing, interpreting, or other suitable processing if necessary, and then storing the program in a computer memory.

It should be understood that, each part of the embodiments of the present disclosure may be implemented by hardware, software, firmware, or a combination thereof. In the above embodiments, multiple steps or methods may be implemented by software and firmware stored in a memory and executed by a suitable instruction execution system. For example, in a case that the steps or methods are implemented by hardware, as in another embodiment, the steps or methods may be implemented by any one or a combination of the following technologies commonly known in the art: discrete logic circuits with logic gate circuits for implementing logic functions for data signals, an application specific integrated circuit with suitable combinational logic gate circuits, a programmable gate array (PGA), a field programmable gate array (FPGA), and the like.

Those skilled in the art may understand that all or part of steps in the methods of the embodiments may be implemented by instructing relevant hardware through a program. The program may be stored in a computer readable storage medium, and during execution, the program may include one or a combination of the steps of the method embodiments.

In addition, various functional units in the embodiments of the present disclosure may be integrated in one processor, or each of the units may exist alone physically, or two or more units are integrated into one module. The integrated module may be implemented in a form of hardware, or may be implemented in a form of software functional module. In a case that the integrated module is implemented in the form of software functional module and serves as an independent product for sale or use, it may be stored in a computer readable storage medium.

The above storage medium may be a read-only memory, a magnetic disk or an optical disk, etc.

Although the embodiments of the present disclosure are shown and described, those ordinary skilled in the art should understand that various changes, modifications, substitutions and alterations may be made to these embodiments without departing from the principle and spirit of the present disclosure, and the scope of the present disclosure is defined by the claims and their equivalents.

1. A method for processing an image, comprising:
acquiring parameters of rectangular images of an inner ring portion and an outer ring portion of a to-be-detected object obtained by scanning in a rotating manner;
pre-processing, based on the parameters of the rectangular images of the inner ring portion and the outer ring portion, a plurality of rectangular images of the inner ring portion and a plurality of rectangular images of the outer ring portion, to form a rectangular image of the to-be-detected object;
initializing, based on the rectangular image of the to-be-detected object, parameters of a target circular image; and
determining a pixel mapping relationship between the target circular image and the rectangular image of the to-be-detected object, and determining, based on the pixel mapping relationship and a pixel value of the rectangular image of the to-be-detected object, a pixel value of the target circular image.

2. The method for processing the image according to claim 1, wherein the rectangular images of the inner ring portion and the rectangular images of the outer ring portion are captured by two line scan cameras respectively, and the two line scan cameras are arranged in a radial direction of the to-be-detected object.

3. The method for processing the image according to claim 1, wherein the parameters of the rectangular images of the inner ring portion and the outer ring portion comprise a redundant width of the rectangular image of the inner ring portion, an overlapping width of the inner ring portion and the outer ring portion, a quantity of rows of the to-be-detected object rotated in a circle, and a quantity of rows moved of the rectangular image of the inner ring portion and/or the outer ring portion.

4. The method for processing the image according to claim 3, wherein the pre-processing comprises:
cropping, based on the quantity of rows of the to-be-detected object rotated once, redundant rows in the rectangular images of the inner ring portion and the rectangular images of the outer ring portion;
cropping, based on the redundant width of the rectangular image of the inner ring portion, redundant parts of the rectangular images of the inner ring portion;
cropping, based on the overlapping width of the inner ring portion and the outer ring portion, the rectangular images of the inner ring portion and/or the rectangular images of the outer ring portion; and
splicing, based on the quantity of rows moved of the rectangular image of the inner ring portion and/or the outer ring portion, a plurality of cropped rectangular images of the outer ring portion and a plurality of cropped rectangular images of the inner ring portion, to acquire the rectangular image of the to-be-detected object.

5. The method for processing the image according to claim 1, wherein the parameters of the target circular image comprise a radius and a spatial matrix of the target circular image, and
the initializing, based on the rectangular image of the to-be-detected object, parameters of a target circular image comprises:
setting the radius of the target circular image to be equal to a width of the rectangular image of the to-be-detected object; and
initializing the spatial matrix, wherein the spatial matrix is a matrix of 2R*2R, and R represents the radius of the target circular image.

6. The method for processing the image according to claim 5, wherein the determining the pixel mapping relationship between the target circular image and the rectangular image of the to-be-detected object comprises:
extracting all points in the spatial matrix of the target circular image that are apart from a central point of the spatial matrix less than or equal to the radius of the target circular image; and
mapping all the extracted points back to corresponding positions in the rectangular image of the to-be-detected object through a preset function to determine the pixel mapping relationship.

7. The method for processing the image according to claim 6, wherein the preset function comprises a conversion relationship between coordinates of a pixel point in the target circular image and coordinates of a pixel point in the rectangular image of the to-be-detected object.

8. A device for processing an image, comprising:
a memory;
a processor; and
a computer program stored in the memory and executable on the processor,
wherein the processor, when executing the computer program, is configured to:
acquire parameters of rectangular images of an inner ring portion and an outer ring portion of a to-be-detected object obtained by scanning in a rotating manner;
pre-process a plurality of rectangular images of the inner ring portion and a plurality of rectangular images of the outer ring portion based on the parameters of the rectangular images of the inner ring portion and the outer ring portion to form a rectangular image of the to-be-detected object;
initialize parameters of a target circular image based on the rectangular image of the to-be-detected object; and
determine a pixel mapping relationship between the target circular image and the rectangular image of the to-be-detected object, and determine a pixel value of the target circular image based on the pixel mapping relationship and a pixel value of the rectangular image of the to-be-detected object.

9. The device for processing the image according to claim 8, wherein the rectangular images of the inner ring portion and the rectangular images of the outer ring portion are captured by two line scan cameras respectively, and the two line scan cameras are arranged in a radial direction of the to-be-detected object.

10. The device for processing the image according to claim 8, wherein the parameters of the rectangular images of the inner ring portion and the outer ring portion comprise a redundant width of the rectangular image of the inner ring portion, an overlapping width of the inner ring portion and the outer ring portion, a quantity of rows of the to-be-detected object rotated once, and a quantity of rows moved of the rectangular image of the inner ring portion and/or the outer ring portion.

11. The device for processing the image according to claim 10, wherein the processor is further configured to:
crop redundant rows in the rectangular images of the inner ring portion and the rectangular images of the outer ring portion based on the quantity of rows of the to-be-detected object rotated once;
crop redundant parts of the rectangular images of the inner ring portion based on the redundant width of the rectangular image of the inner ring portion;
crop the rectangular images of the inner ring portion and/or the rectangular images of the outer ring portion based on the overlapping width of the inner ring portion and the outer ring portion; and
splice a plurality of cropped rectangular images of the outer ring portion and a plurality of cropped rectangular images of the inner ring portion based on the quantity of rows moved of the rectangular image of the inner ring portion and/or the outer ring portion to acquire the rectangular image of the to-be-detected object.

12. The device for processing the image according to claim 8, wherein the parameters of the target circular image comprise a radius and a spatial matrix of the target circular image, and the processor is further configured to:
set the radius of the target circular image to be equal to a width of the rectangular image of the to-be-detected object; and
initialize the spatial matrix, wherein the spatial matrix is a matrix of 2R*2R, and R represents the radius of the target circular image.

13. The device for processing the image according to claim 12, wherein the processor is further configured to:
extract all points in the spatial matrix of the target circular image that are apart from a central point of the spatial matrix less than or equal to the radius of the target circular image; and
map all the extracted points back to corresponding positions in the rectangular image of the to-be-detected object through a preset function to determine the pixel mapping relationship.

14. The device for processing the image according to claim 13, wherein the preset function comprises a conversion relationship between coordinates of a pixel point in the target circular image and coordinates of a pixel point in the rectangular image of the to-be-detected object.

15. (canceled)

16. An optical system, comprising the device for processing the image according to claim 8.

17. A non-transitory computer readable storage medium storing a computer program thereon, wherein the computer program, when executed by a processor, implements the method for processing the image, the method comprises:
acquiring parameters of rectangular images of an inner ring portion and an outer ring portion of a to-be-detected object obtained by scanning in a rotating manner;
pre-processing, based on the parameters of the rectangular images of the inner ring portion and the outer ring portion, a plurality of rectangular images of the inner ring portion and a plurality of rectangular images of the outer ring portion, to form a rectangular image of the to-be-detected object;
initializing, based on the rectangular image of the to-be-detected object, parameters of a target circular image; and
determining a pixel mapping relationship between the target circular image and the rectangular image of the to-be-detected object, and determining, based on the pixel mapping relationship and a pixel value of the rectangular image of the to-be-detected object, a pixel value of the target circular image.
